(19) United States
(12) Patent Application Publication
(10) Pub. No.: US 2024/0382910 A1
(43) Pub. Date: Nov. 21, 2024

(54) HYDROPHILIC FILTER MEMBRANE WITH PENDANT HYDROPHILIC GROUPS, AND RELATED METHODS OF PREPARATION AND USE

(71) Applicant: ENTEGRIS, INC., Billerica, MA (US)

(72) Inventors: Nicholas J. Filipancic, Bedford, MA (US); James Hamzik, North Billerica, MA (US)

(21) Appl. No.: 18/786,243

(22) Filed: Jul. 26, 2024

Related U.S. Application Data
(62) Division of application No. 16/674,200, filed on Nov. 5, 2019.
(60) Provisional application No. 62/773,661, filed on Nov. 30, 2018.

(51) Int. Cl. B01D 71/82; B01D 67/00; B01D 69/02; B01D 71/56; C08J 7/18

(52) U.S. Cl. CPC B01D 71/82; B01D 67/009; B01D 67/00931; B01D 67/0095; B01D 69/02; B01D 71/56; C08J 7/18; B01D 2323/345; B01D 2323/36; B01D 2325/0283; B01D 2325/14; B01D 2325/16; C08J 2377/00

(57) ABSTRACT

Described are hydrophilic polymers (including in the form of a filter membranes that includes hydrophilic polymer) having pendant ionic groups; to methods of making the hydrophilic polymer with pendant ionic groups and derivative membranes and filters; and to method of using the filter membranes for filtering a fluid such as a liquid chemical to remove unwanted material from the fluid.

This application is a divisional of U.S. patent application Ser. No. 16/674,200 filed on Nov. 5, 2019, which claims the benefit of U.S. Application No. 62/773,661 filed on Nov. 30, 2018, which is hereby incorporated by reference in its entirety.

### FIELD

The following description relates to porous polymeric filter membranes that include a hydrophilic polymer having pendant ionic groups; to methods of making the filter membranes and filters that include such a filter membrane; and to method of using the filter membranes for filtering a fluid such as a liquid chemical to remove unwanted material from the fluid.

### BACKGROUND

Filter products are indispensable tools of modern industry, used to remove unwanted materials from a flow of a useful fluid. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

To perform a filtration function, a filter includes a filter membrane that is responsible for removing unwanted material from a fluid that passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 microns. Membranes with average pore size of from about 0.001 to about 0.05 micron are sometimes classified as ultrafilter membranes. Membranes with pore sizes between about 0.05 and 10 microns are sometimes referred to as microporous membranes.

A filter membrane having micron or sub-micron-range pore sizes can be effective to remove an unwanted material from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

The removal of ionic materials such as dissolved anions or cations from solutions is important in many industries, such as the microelectronics industry, where ionic contaminants and particles in very small concentrations can adversely affect the quality and performance of microprocessors and memory devices. Dissolved ionic materials can be removed by way of a non-sieving filtration mechanism, by microporous filter membranes that are made of polymeric materials that attract dissolved ionic materials. Examples of such microporous membranes are made from chemically inert, low surface energy polymers like ultrahigh molecular weight polyethylene (“UPE”), polytetrafluoroethylene, nylon, and the like. Nylon filter membranes, in specific, are used in a variety of different filtration applications in the semiconductor processing industry, due to the ability to form nylon into filter membranes that exhibit high permeability and due to good non-sieving filtration behavior of nylon.

### SUMMARY

Filtration membranes made of hydrophilic polymer such as nylon are used for various filtration applications in the semiconductor and microelectronics industries. Nylon can be made formed into a filtration membrane that exhibits high permeability, hydrophilicity, and good non-sieving filtration performance. Nylon polymers have an inherent surface charge that is dependent on the type of nylon, and that contributes to the non-sieving filtration properties of a nylon polymer. The non-sieving filtration properties of a hydrophilic polymer such as nylon could be improved, if additional charged functionalities could be added to the membrane with minimal loss of overall flow properties and filtering properties to the membrane.

One general mode of modifying a surface of a polymer is to graft a functional (ionic) group onto a polymer surface. However, techniques for grafting ionically-charged groups onto a polymer are not necessarily effective to allow grafting onto all types of polymers. Many grafting techniques involve the use of a photoinitiator that has a hydrophobic nature. For grafting a functional group onto a polymer that has a hydrophobic surface, e.g., polyethylene, the use of a hydrophobic photoinitiator may work well. For other polymers, especially polymers such as nylons that exhibit a hydrophilic surface, these techniques are not as effective, if useful at all.

Disclosed herein is a new technique for grafting ionic groups to a hydrophilic polymer. The technique involves applying a hydrophobic photoinitiator, in solution, to a surface of a hydrophilic polymer followed by an optional drying step and then re-wetting the surface with a monomer solution. The techniques can ensure that a relatively high level of photoinitiator is deposited on the surface of the hydrophilic polymer. The level of photoinitiator that is presented to the surface is sufficient to allow grafting of a charged monomer onto the hydrophilic surface in an amount that will be useful or advantageously high with respect to allowing the hydrophilic polymer (as part of a filter membrane) to be effective as a filter membrane. The steps of chemically attaching the ionic groups onto hydrophilic polymer of a filter membrane do not have any substantial effect on the amount (flow rate or flux) of fluid that can be passed through the filter membrane—the amount (rate or flow) of fluid that can be passed through the filter membrane is not substantially detrimentally affected by chemically adding the ionic groups to the filter membrane. At the same time, the filtering performance of the filter membrane, especially non-sieving filtering as measured by dye-binding capacity, particle retention, and metal ion removal, can be improved by a significant amount.

In one aspect, a porous polymeric filter membrane includes a hydrophilic polymer that includes: a polymer backbone; pendant hydrophilic groups selected from hydroxyl groups, amine groups, carboxylic groups, or a combination thereof; and pendant ionic groups that are different from the pendent hydrophilic groups.

In another aspect, a method of grafting ionic groups to a hydrophilic polymer is disclosed. The method includes: contacting hydrophilic polymer with photoinitiator solution comprising solvent and photoinitiator to place photoinitiator at surfaces of the hydrophilic polymer; after contacting the surfaces with the photoinitiator solution to place photoinitiator at the surfaces, contacting the surfaces with monomer solution comprising charged monomer comprising the ionic groups; exposing the surfaces to electromagnetic radiation to cause the ionic groups to become grafted to the hydrophilic polymer.

A method of preparing a porous polymeric filter membrane includes hydrophilic polymer, with grafted ionic groups. The method includes: contacting the membrane with photoinitiator solution comprising solvent and photoinitiator to place photoinitiator at surfaces of the membrane; after contacting the surfaces with the photoinitiator solution to place the photoinitiator at the surfaces, contacting the surfaces with monomer solution comprising charged monomer comprising the ionic groups; and exposing the surfaces to electromagnetic radiation to cause the ionic groups to become grafted to the hydrophilic polymer.

### BRIEF DESCRIPTION OF THE DRAWING

FIG. 1 (which is schematic and not necessarily to scale) shows an example of a filter product as described herein.

### DETAILED DESCRIPTION

The following description relates to novel and inventive methods for chemically attaching, i.e., “grafting,” ionic groups onto a hydrophilic polymer; to hydrophilic polymeric materials that include the pendent ionic groups; to filter membranes, filter components, and filters that include a such a hydrophilic polymeric material; and to methods of using a filter membrane or filter component for filtering a fluid to remove unwanted material from the fluid.

Applicant has determined that chemically attaching charged (“ionic”) chemical groups to a hydrophilic polymer by certain chemical grafting techniques that include the use of photoinitiator, involves certain specific technical challenges. Many of these techniques involve contacting a polymer surface with a solution that contains a charged reactive compound (e.g., “charged monomer”) and photoinitiator, then exposing the polymer and the solution to electromagnetic radiation. The charged monomer includes a reactive moiety (e.g., an unsaturated moiety) and the charged chemical group that is to be chemically attached to the polymer. When the solution that contains the charged monomer, the polymer, and the photoinitiator, is exposed to the radiation, the photoinitiator initiates a chemical reaction between the unsaturated moiety and the hydrophilic polymer. The reaction results in the unsaturated moiety becoming chemically attached to the polymer, i.e., “grafted” to the polymer.

The ionic group can be any group. The pendant ionic groups are different from the pendant hydrophilic groups. In particular embodiments in which the hydrophilic polymer is included in a filter membrane, the ionic group can be effective to improve the filtering performance of the filter membrane, especially the non-sieving filtering performance of the filter membrane. Examples of ionic groups that can be included on hydrophilic polymer as described, in particular on a hydrophilic polymer that is included in a filter membrane, include: cationic nitrogen-containing ionic groups, anionic sulfur-containing ionic groups, and anionic phosphorus-containing ionic groups, including chemical counterparts thereof (e.g., salts or acids). As certain particular examples, the pendant ionic group may be: a cationic nitrogen-containing cyclic aromatic group, a cationic imidazole or a cationic amine, or an anionic phosphonic acid group or anionic sulfonic acid group.

Certain particular technical challenges exist when these techniques are used to attach a charged monomer onto a hydrophilic polymer. Typical photoinitiators (e.g., benzophenone and benzophenone derivatives) are hydrophobic and are not inherently attracted to hydrophilic surfaces of a hydrophilic polymer. The challenge that results is to place an effective amount of the hydrophobic photoinitiator at a surface of a hydrophilic polymer.

Disclosed herein are new techniques by which charged monomers can be chemically attached to, i.e., grafted to, hydrophilic polymer or an article that is made from the hydrophilic polymer (including but not limited a porous filter membrane). The techniques include, generally: placing photoinitiator at a surface of a hydrophilic polymer; then placing charged monomer at the surface; and then exposing the photoinitiator and the charged monomer present at the surface of the hydrophilic polymer to radiation. The radiation causes the photoinitiator to initiate a reaction between the unsaturated moiety and the hydrophilic polymer whereby the unsaturated moiety becomes chemically attached to, i.e., “grafted” to, the polymer, so that the resultant hydrophilic polymer includes the charged (ionic) chemical group chemically attached to the hydrophilic polymer through a covalent chemical bond.

A more specific example of this method involves grafting ionic groups onto a porous filter membrane (e.g., a hydrophilic porous filter membrane) that is made to include hydrophilic polymer. The method includes chemically attaching the charged chemical groups of the charged monomers to hydrophilic polymeric surfaces of the filter membrane, including (preferably) at inner pore surfaces of the membrane. The method can include: contacting the filter membrane with photoinitiator solution that contains solvent and photoinitiator to place the photoinitiator at surfaces of the hydrophilic polymer, including inner pore surfaces; optionally removing an excess amount of the photoinitiator solution from the surfaces, e.g., by a rinsing (with water) step, a drying (solvent evaporation) step, or both a rinsing step and a drying step; after contacting the surface with the photoinitiator solution and after optionally removing excess photoinitiator solution from the surface, placing charged monomer at the surfaces; and exposing the surfaces (with photoinitiator and charged monomer) to electromagnetic radiation to cause the charged monomer to react with the hydrophilic polymer and become chemically attached to the hydrophilic polymer through a covalent chemical bond, i.e., grafted to the hydrophilic polymer.

As compared to certain previous grafting methods, the present description involves using hydrophobic photoinitiator to chemically attach charged (ionic) chemical groups to polymer that is hydrophilic. As used herein, the term “hydrophilic,” for describing hydrophilic polymer, refers to polymers that attract water molecules due to the presence of a sufficient amount of hydrophilic pendant functional groups attached to the polymeric backbone, such as hydroxyl (—OH) groups, carboxyl groups (—COOH), amino groups, (—NH₂), or similar functional groups that are attached to a polymer backbone. In some embodiments the pendent hydrophilic groups are selected from the group consisting of hydroxyl groups, amine groups, carboxylic groups, or combinations thereof. When a hydrophilic polymer is formed into a porous filter membrane, these hydrophilic groups assist in absorbing water onto the porous filter membrane.

Example hydrophilic polymers are nylon polymers, which includes polyamide polymers. These are typically understood to include copolymers and terpolymers that include recurring amido groups in a polymeric backbone. Generally, nylon and polyamide resins include copolymers of a diamine and a dicarboxylic acid, or homopolymers of a lactam and an amino acid. Preferred nylons for use in fabricating filter membrane as described herein copolymers of hexamethylene diamine and adipic acid (nylon 66), copolymers of hexamethylene diamine and sebacic acid (nylon 610), homopolymers of polycaprolactam (nylon 6) and copolymers of tetramethylenediamine and adipic acid (nylon 46). Nylon polymers are available in a wide variety of grades, which vary appreciably with respect to molecular weight, within the range from about 15,000 to about 42,000 (number average molecular weight) and in other characteristics.

In some embodiments, the polymer, or an article thereof (e.g., porous filter membrane), may be made entirely of hydrophilic polymer or entirely of nylon polymer, e.g., may consist of or consist essentially of hydrophilic polymer such as nylon polymer, and is not blended with another polymer that is non-hydrophobic or non-nylon. The polymer can be non-fluorinated and does not require and may specifically exclude other types of polymers such as fluoropolymers, perfluoropolymers, polyolefins (e.g., polyethylene, polypropylene), etc. As used herein, a material that “consists essentially of” specified ingredients or materials is one that contains the stated ingredients or materials and not more than an insignificant amount of other material, e.g., that contains at least 98, 99, 99.5, 99.9, or 99.99 percent by weight of the specified ingredients or materials and not more than 2, 1, 0.5, 0.1, or 0.01 weight percent of any other ingredient or material. Alternately, if useful or desired, a polymer (or a filter membrane or other article) may include an amount of non-hydrophilic polymer blended with hydrophilic polymer, for example a minor amount (less than 50, 40, 30, 20, 10, or 5 weight percent) of non-hydrophilic monomer.

According to methods as described, photoinitiator is placed at surfaces of hydrophilic polymer, e.g., at surfaces of a porous filter membrane or other article that contains hydrophilic polymer. By preferred techniques, photoinitiator can be dissolved in solvent to form a photoinitiator solution that is then applied to the hydrophilic polymer, to place the photoinitiator at the surfaces. The photoinitiator may be dissolved in liquid solvent, which may be water, organic solvent, or a combination of organic solvent and water, to form a photoinitiator solution. The photoinitiator solution is then brought into contact with the polymer in any useful manner such as by spraying, submerging, soaking, adsorbing, or the like.

The solvent of the photoinitiator solution can be any solvent that is effective to dissolve the photoinitiator and deliver the photoinitiator to surfaces of the hydrophilic polymer, e.g., to surfaces of a hydrophilic porous polymeric membrane. For a polymer that is hydrophilic, and a photoinitiator that is hydrophobic, the solvent must be compatible with each of these two components to successfully bring a desirably high amount of the hydrophobic photoinitiator into contact with surfaces of the hydrophilic polymer, including into contact with internal pores of a filter membrane made with hydrophilic polymer. To accomplish this, solvent of example photoinitiator solutions as described may contain at least some amount of water, while still being capable of dissolving a useful amount of the photoinitiator. Including water as part of the photoinitiator solvent can be effective to make the solvent more polar, which can make the delivery of (e.g., precipitation of) the hydrophobic photoinitiator from the solvent, onto the hydrophilic polymer, more efficient. Additionally, the water may improve the web handling of the membrane during the process, because exposing a hydrophilic polymer such as nylon to more concentrated, e.g., pure, organic solvent may tend to cause deformation of the polymeric membrane during handling.

The term “solvent” refers to any liquid that is effective to contain a useful amount of dissolved photoinitiator, to allow the liquid to carry the dissolved photoinitiator to surfaces of a hydrophilic polymer or article made to include hydrophilic polymer, e.g., a polymeric filter membrane including inner pore surfaces. The solvent can include organic solvent, water, or both. Examples of organic solvents include alcohols, especially lower alcohols (C1 to C5 alcohols), with isopropanol and methanol being useful examples.

Exemplary solvents for a photoinitiator solution include, consist of, or consist essentially of a mixture of organic solvent and water, for example a blend of water and a lower (C1 through C4) alcohol, such as a blend of methanol and water or a blend of isopropanol and water. Combinations of a lower alcohol such as isopropanol or methanol, with water, may be particularly effective in dissolving a hydrophobic initiator, e.g., benzophenone (or a derivative thereof), while still being highly effective for wetting surfaces of hydrophilic polymer such as surfaces (including interior pore surfaces) of a porous filter membrane made with hydrophilic polymer. The effectiveness of these solvent mixtures to dissolve hydrophobic photoinitiator (e.g., benzophenone or a derivative thereof), and to wet a hydrophilic substrate, can allow the solvent mixtures to be used to effectively deliver a useful amount of hydrophobic photoinitiator onto surfaces of a hydrophilic polymer, including internal pore surfaces of a porous hydrophilic filter membrane. The relative amounts of organic solvent (e.g., lower alcohol such as methanol, isopropanol, or a mixture thereof) and water in the solvent may be any effective amounts, for example a ratio (wt:wt) of water: organic solvent may be in a range from 10:90 to 90:10, 20:80 to 80:20, e.g., from 30:70 to 70:30, or from 40:60 to 60:40.

The photoinitiator can be any photoinitiator that will effectively respond to radiation (e.g. ultraviolet radiation) to initiate a reaction between a reactive group of a charged monomer as described herein, and hydrophilic polymer. Examples include photoinitiators known in the chemical arts as “type II” photoinitiators. Known and useful examples of type II photoinitiators include benzophenone and benzophenone derivatives.

The amount of photoinitiator in a photoinitiator solution can be any amount (concentration) that is sufficiently high to allow the photoinitiator solution to deliver a desired, useful, or maximum amount of the photoinitiator to a hydrophilic polymer surface. The amount and its method of application should be sufficient to place an amount of photoinitiator at the polymer surface that is effective for reacting a desirably high amount of the charged monomer with the polymer surface. Examples of useful amounts of photoinitiator in a photoinitiator solution may be in a range of up to 5 weight percent, e.g., from 0.1 or 0.5 to 4.5 weight percent, or from 1 or 2 to 3 or 4 weight percent.

The photoinitiator solution can be applied to surfaces of hydrophilic polymer by any useful technique, such as by spraying the photoinitiator solution onto the hydrophilic polymer, by submerging or soaking the hydrophilic polymer in the photoinitiator solution, or the like. Desirably, the entire surface of an article that includes the hydrophilic polymer can be contacted with and wetted by the photoinitiator solution, including for example all internal surfaces of a porous filter membrane. If necessary, the application step may include manipulation of the hydrophilic polymer or an article that includes the hydrophilic polymer, e.g., by rolling or squeezing a porous filter medium to cause wetting of all surfaces of the porous filter medium. In some embodiments, the photoinitiator solution comprises from 0.1 to 2 weight percent benzophenone or benzophenone derivative, water and one or more of isopropanol and methanol. In some embodiments, the photoinitiator solution comprises from 20 to 80 parts by weight isopropanol, and from 80 to 20 parts by weight percent isopropanol, based on 100 parts by weight total isopropanol and water.

Subsequently, if desired, a portion of the photoinitiator solution residing on the surface of the hydrophilic polymer surface may be removed, while still effectively leaving a desired amount of the photoinitiator solution on the surface. The photoinitiator solution may be present in an amount that is more than necessary, and an excess amount may be removed by any one or more techniques of mechanical removal. For a porous filter membrane, examples of techniques for removing excess photoinitiator solution include drip-drying, squeezing, wringing, folding, or rolling the filter membrane, using mechanical force or pressure such as a roller, rinsing with a spray or water bath (e.g., with deionized water), or by evaporating solvent from the photoinitiator solution that is present on the hydrophilic polymer surface by use of one or more of airflow or heat, e.g., by use of a fan or an “air-knife” dryer, heat, or a combination of these.

By one optional step of removing excess photoinitiator solution, the hydrophilic polymer, e.g., porous hydrophilic filter membrane, that includes photoinitiator solution contacting surfaces thereof may be rinsed using water, e.g., deionized water. The rinsing step may be performed by any useful technique, such as by spraying rinse (e.g., deionized) water onto the hydrophilic polymer, by submerging or soaking the hydrophilic polymer water (e.g., deionized water), or the like, whereby at least a portion of excess photoinitiator solution (including organic solvent thereof) is removed from the hydrophilic polymer surface. The rinse step should allow for a useful amount of the photoinitiator to remain at surfaces of the hydrophilic polymer, preferably with a reduced amount of solvent from the photoinitiator solution remaining on the surfaces.

In a different optional step of removing a portion of photoinitiator solution from surfaces of hydrophilic monomer, which may optionally be performed after a rinsing step or a mechanical drying step or both, the hydrophilic polymer (e.g., a porous hydrophilic filter membrane) having photoinitiator solution contacting surfaces thereof can be treated to remove solvent of the photoinitiator solution by drying the solvent by evaporation, to leave a concentrated amount of the photoinitiator at the hydrophilic polymer surface. This type of drying step, to evaporate solvent of the photoinitiator solution at surfaces of the hydrophilic polymer, can be performed by applying heat to the photoinitiator solution, by passing a flow of air or another gaseous fluid over the photoinitiator solution, or by allowing the solvent to evaporate from the photoinitiator solution by resting at ambient conditions, e.g., in air at room temperature, for an amount of time that is effective to allow a desired portion of the solvent of the photoinitiator solution to evaporate. Desirably, a substantial portion of the solvent can be evaporated and removed from the photoinitiator solution, such as at least 40, 50, 70, or 90 weight percent of the solvent. As a result, a concentrated amount of the photoinitiator remains on surfaces of the hydrophilic polymer, preferably in a fairly uniform distribution over the entire surface, e.g., including at interior pores of a porous filtration membrane.

Optionally, as desired, after a drying step hydrophilic polymer having photoinitiator present at surfaces thereof may be again wetted with water, e.g., deionized water, such as by spraying deionized water on the hydrophilic polymer, submerging the hydrophilic polymer in deionized water, or by any other technique that is effective to re-wet the photoinitiator without removing the photoinitiator from the surfaces of the hydrophilic polymer.

According to methods as described, a next step, following placing photoinitiator at surfaces of the hydrophilic polymer (with optional drying or wetting steps), can be to place charged monomer at the surfaces in combination with the photoinitiator. The charged monomer can be placed at the surfaces, having the photoinitiator previously placed thereon, by any useful technique, with useful examples including by contacting the surfaces with monomer solution that contains the charged monomer dissolved in solvent. Specific examples of these techniques include spraying, submerging, soaking, adsorbing, or the like. After the charged monomer is successfully placed at the surfaces in combination with the photoinitiator, the surfaces (with photoinitiator and charged monomer) are exposed to radiation to initiate a chemical reaction that chemically attaches (through a covalent chemical bond) the charged monomer to the hydrophilic polymer, a process often referred to as chemical “grafting.”

The charged monomer may be a reactive compound that includes a reactive moiety such as an unsaturated moiety (e.g., vinyl, acrylate, methacrylate, etc.) and an ionic moiety, which may be anionic or cationic.

Examples of suitable cationic charged monomers include acrylate, methacrylate, acrylamide, methacrylamide, amine (e.g., primary amine, secondary amine, tertiary amine, and quaternary amine), and vinyl types having a quaternary ammonium, imidazolium, phosphonium, guanidinium, sulfonium, or pyridinium functionality. Examples of suitable acrylate monomers include 2-(dimethylamino)ethyl hydrochloride acrylate and [2-(acryloyloxy)ethyl]trimethylammonium chloride. Examples of suitable methacrylate monomers include 2-aminoethyl methacrylate hydrochloride, N-(3-aminopropyl) methacrylate hydrochloride, 2-(dimethylamino)ethyl methacrylate hydrochloride, [3-(methacryloylamino)propyl]trimethylammonium chloride solution, and [2-(methacryloyloxy)ethyl]trimethylammonium chloride. Examples of suitable acrylamide monomers include acrylamidopropyl trimethylammonium chloride. Examples of suitable methacrylamide monomers include 2-aminoethyl methacrylamide hydrochloride, N-(2-aminoethyl) methacrylamide hydrochloride, and N-(3-Aminopropyl)-methacrylamide hydrochloride. Other suitable monomers include diallyldimethylammonium chloride, allylamine hydrochloride, vinyl imidazolium hydrochloride, vinyl pyridinium hydrochloride and vinyl benzyl trimethyl ammonium chloride.

Suitable anionic monomers include acrylate, methacrylate, acrylamide, methacrylamide and vinyl types having a sulfonic acid, carboxylic acid, phosphonic acid or phosphoric acid functionality. Examples of suitable acrylate monomers include 2-ethylacrylic acid, acrylic acid, 2-carboxyethyl acrylate, 3-sulfopropyl acrylate potassium salt, 2-propyl acrylic acid, and 2-(trifluoromethyl)acrylic acid. Examples of suitable methacrylate monomers include methacrylic acid, 2-methyl-2-propene-1-sulfonic acid sodium salt, mono-2-(methacryloyloxy)ethyl maleate, and 3-sulfopropyl methacrylate potassium salt. An example of a suitable acrylamide monomer is 2-acrylamido-2-methyl-1-propanesulfonic acid. An example of a suitable methacrylamide monomers is 3-methacrylamido phenyl boronic acid. Other suitable monomers include vinyl sulfonic acid (or vinylsulfonic acid sodium salt) and vinyl phosphonic acid (and salts thereof).

Other suitable monomers are N-(hydroxymethyl)acrylamide (HMAD), (3-acrylamidopropyl)trimethylammonium chloride (APTAC), and (vinylbenzyl)trimethylammonium chloride (VBTAC).

The type of solvent used for the monomer solution can be any that is effective to allow the monomer solution to dissolved and deliver a useful amount of charged monomer to surfaces of the hydrophilic polymer. The preferred solvent for the monomer solution is water or water with the addition of an organic solvent. The solvent can include organic solvent, water, or both. Examples of organic solvents include alcohols, especially lower alcohols (C1 to C5 alcohols), with isopropanol, methanol, and hexylene glycol being useful examples. The specific solvent used for a particular process, monomer solution, and charged monomer, can be based on factors such as the type and amount of charged monomer in the monomer solution, the type of hydrophilic polymer, and other factors. In a solvent that contains both water and organic solvent, the organic solvent may be included in any amount, e.g., in an amount that is less than 90, 75, 50, 40, 30, 20, or 10 percent by weight; as an example, a useful solvent composition may contain from 1 to 10 percent by weight hexylene glycol in water.

The amount of charged monomer in a monomer solution can be any amount (concentration) that is sufficiently high to allow the monomer solution to deliver a desired, useful, or maximum amount of the charged monomer to the hydrophilic polymer surface. The amount of monomer solution, the concentration of charged monomer in the monomer solution, and the method used to apply the monomer solution to the hydrophilic polymer, should be sufficient to place an amount of charged monomer at the polymer surface that is effective for reacting a desirably high amount of the charged monomer with the hydrophilic polymer surface. Examples of useful amounts of monomer in a monomer solution may be in a range of up to 5 or 10 weight percent, e.g., from 0.5 to 5 weight percent or from 1 or 2 to 3 or 4 weight percent. In some embodiments, the charged monomer comprises vinyl imidazole, 2-acrylamido-2-methylpropane sulfonic acid, (3-acrylamido propyl)trimethyl ammonium chloride, vinyl sulfonic acid, vinyl phosphonic acid, acrylic acid, (vinylbenzyl)trimethylammonium chloride, or polydiallyldimethylammonium chloride. In some embodiments, the monomer solution comprises from 0.5 to 10 weight percent charged monomer dissolved in from 90 to 99.5 weight percent deionized water, based on total weight monomer solution.

After the monomer solution has been effectively delivered to surfaces of the hydrophilic polymer (that includes the photoinitiator previously placed thereon), the hydrophilic polymer (with photoinitiator and charged monomer at surfaces thereof) is exposed to electromagnetic radiation, typically within the ultraviolet portion of the spectrum, or to another energy source that is effective to cause the photoinitiator to initiate a chemical reaction that results in the reactive moiety of the charged monomer reacting with and becoming chemically (covalently) attached to the hydrophilic polymer.

The amount of ionic groups that can be attached to a hydrophilic polymer, stated in terms of the amount of reactive monomer chemically attached to hydrophilic monomer or a filter medium that contains the hydrophilic monomer, can be any useful amount, e.g., an amount that will be effective to increase a non-sieving filtering function of a hydrophilic filter membrane to which ionic groups are attached. Preferably the presence and amount of the pendant ionic group does not produce a substantial or an un-acceptable level of a detrimental impact on other properties of the filter membrane such as a flow property.

For example hydrophilic polymers, having had ionic groups chemically attached thereto by use of a grafting technique that involves photoinitiator, articles or compositions that include these polymers, such as a filter membrane made with the polymer, may (while not preferred) include a very small yet analytically detectable (residual) amount of photoinitiator.

In various examples of methods and devices of the present description, the hydrophilic polymer can be included in a porous filter membrane. As used herein, a “porous filter membrane” is a porous solid that contains porous (e.g., microporous) interconnecting passages that extend from one surface of the membrane to an opposite surface of the membrane. The passages generally provide tortuous tunnels or paths through which a liquid being filtered must pass. Any particles contained in this liquid that are larger than the pores are either prevented from entering the microporous membrane or are trapped within the pores of the microporous membrane (i.e., are removed by a sieving-type filtration mechanism) as fluid containing the particles passes through the membrane. Particles that are smaller than the pores are also trapped or absorbed onto the pore structure, e.g., may be removed by a non-sieving filtration mechanism. The liquid and possible a reduced amount of particles or dissolved materials pass through the microporous membrane.

Example porous polymeric filter membrane as described herein (considered either before or after the steps for grafting ionic groups to surfaces thereon) can be characterized by physical features that include pore size, bubble point, and porosity.

The porous polymeric filter membrane may have any pore size that will allow the filter membrane to be effective for performing as a filter membrane, e.g., as described herein, including pores of a size (average pore size) sometimes considered as a microporous filter membrane or an ultrafilter membrane. Examples of useful or preferred porous membranes can have an average pore size in a range on from about 0.001 microns to about 1 or 2 microns, e.g., from 0.01 to 0.8 microns, with the pore size be selected based on one or more factors that include: the particle size or type of impurity to be removed, pressure and pressure drop requirements, and viscosity requirements of a liquid being processed by the filter. An ultrafilter membrane can have an average pore size in a range from 0.001 microns to about 0.05 microns. Pore size is often reported as average pore size of a porous material, which can be measured by known techniques such as by Mercury Porosimetry (MP), Scanning Electron Microscopy (SEM), Liquid Displacement (LLDP), or Atomic Force Microscopy (AFM).

Bubble point is also a known feature of a porous membrane. By a bubble point test method, a sample of porous polymeric filter membrane is immersed in and wetted with a liquid having a known surface tension, and a gas pressure is applied to one side of the sample. The gas pressure is gradually increased. The minimum pressure at which the gas flows through the sample is called a bubble point. Examples of useful bubble points of a porous polymeric filter membrane that is useful or preferred according to the present description, measured using HFE 7200, at a temperature of 20-25 degrees Celsius, can be in a range from 2 to 400 psi, e.g., in a range from 20 to 200 psi. In some embodiments, the bubble point may be in a range from 5 to 200 psi, measured using HFE 7200, at a temperature of 20-25 degrees Celsius.

A porous polymer filter layer as described may have any porosity that will allow the porous polymer filter layer to be effective as described herein. Example porous polymer filter layers can have a relatively high porosity, for example a porosity of at least 60, 70 or 80 percent. As used herein, and in the art of porous bodies, a “porosity” of a porous body (also sometimes referred to as void fraction) is a measure of the void (i.e. “empty”) space in the body as a percent of the total volume of the body, and is calculated as a fraction of the volume of voids of the body over the total volume of the body. A body that has zero percent porosity is completely solid.

A porous polymeric filter membrane as described can be in the form of a sheet or hollow fiber having any useful thickness, e.g., a thickness in a range from 5 to 100 microns, e.g., from 10 or 20 to 50 or 80 microns.

A filter membrane as described can be useful for filtering a liquid to remove undesired material (e.g., contaminants or impurities) from the liquid to produce a high purity liquid that can be used as a material of an industrial process. The filter membrane can be useful to remove a dissolved or suspended contaminant or impurity from a liquid that is caused to flow through the coated filter membrane, either by a sieving mechanism or a non-sieving mechanism, and preferably by both a combined non-sieving and a sieving mechanism. The hydrophilic filter membrane itself (before having ionic groups attached thereto) may exhibit effective sieving and non-sieving filtering properties, and desired flow properties. The same hydrophilic filter membrane that further includes chemically attached pendant ionic groups as described, can exhibit comparable sieving filtering properties, useful or comparable (not unduly diminished) flow properties, and improved (e.g., substantially improved) non-sieving filtering properties.

A filter membrane of the present description can be useful with any type of industrial process that requires a high purity liquid material as an input. Non-limiting examples of such processes include processes of preparing microelectronic or semiconductor devices, a specific example of which is a method of filtering a liquid process material (e.g., solvent or solvent-containing liquid) used for semiconductor photolithography. Examples of contaminants present in a process liquid or solvent used for preparing microelectronic or semiconductor devices may include metal ions dissolved in the liquid, solid particulates suspended in the liquid, and gelled or coagulated materials (e.g., generated during photolithography) present in the liquid.

Particular examples of filter membranes as described can be used to purify a liquid chemical that is used or useful in a semiconductor or microelectronic fabrication application, e.g., for filtering a liquid solvent or other process liquid used in a method of semiconductor photolithography. Some specific, non-limiting, examples of solvents that can be filtered using a filter membrane as described include: n-butyl acetate (nBA), isopropyl alcohol (IPA), 2-ethoxyethyl acetate (2EEA), a xylene, cyclohexanone, ethyl lactate, methyl isobutyl carbinol (MIBC), methyl Isobutyl Ketone (MIBK), isoamyl acetate, undecane, propylene glycol methyl ether (PGME), and propylene glycol monomethyl ether acetate (PGMEA). Example filter membranes as described may be effective to remove metals from solvents that contain water, amines, or both, e.g., bases and aqueous bases such as NH₄OH, tetramethyl ammonia hydroxide (TMAH) and comparable solutions, which may optionally contain water. In some embodiments liquid including a solvent selected from: tetramethyl ammonium hydroxide (TMAH) or NH₄OH is pass through a filter having a membrane described herein and removes metal from the solvent. In some embodiments, passing the solvent-containing liquid through the membrane to remove metal from the solvent-containing liquid results in a concentration of metal in the solvent-containing liquid being reduced.

A filter membrane as described, including the described pendant ionic groups chemically attached to hydrophilic polymer, can also be characterized in terms of dye-binding capacity of the filter membrane. In specific, a charged dye can be caused to bind to surfaces of the filtration membrane. The amount of the dye that can be bound to the filtration membrane can be measured quantitatively by spectroscopic methods based on a difference in measured absorption readings of the membrane at an absorption frequency of the dye. The dye-binding capacity can be assessed by use of a negatively-charged dye, and also by use of a positively-charged dye. According to preferred filter membranes as described, a filter membrane made using hydrophilic polymer, with ionic groups pendant from the hydrophilic polymer, as described, can have a dye-binding capacity for a positively-charged dye, for a negatively-charged dye, or both, that is greater than a comparable filter membrane that includes the same hydrophilic filter membrane made of the same polymer but that does not include the pendant ionic groups; i.e., a filter membrane made using hydrophilic polymer without no pendant ionic groups has less (e.g., significantly less) dye-binding capacity than the same filter membrane containing the hydrophilic polymer with pendant ionic groups, as described.

A coated filter membrane made using hydrophilic polymer, with pendant ionic groups, may have a dye-binding capacity for methylene blue dye that is at least 1 microgram per centimeter squared of the filter membrane (μg/cm²), e.g., greater than 1, or 10, 20, or 50 μg/cm²; alternately or in addition, a coated filter membrane as described may have a dye-binding capacity for Ponceau-S dye that is at least 1 μg/cm², e.g., greater than 1, 10, 20, or 50 μg/cm².

Alternately or in addition, dye-binding capacity of a filter membrane of the present description can be measured in terms of an improvement relative to a comparable filter membrane made using hydrophilic polymer, and that is otherwise the same, but that does not contain pendant ionic groups as described herein. Example filter membranes of the present invention can exhibit a dye-binding capacity that is at least 10, 25, 50, or 100 percent improved relative to the dye-binding capacity of the same hydrophilic filter membrane without the pendant ionic groups; a filter membrane made using hydrophilic polymer, and that contains pendant ionic groups as described, can have a greater (e.g., significantly greater) dye-binding capacity compared to the same filter membrane (in terms of pore size, porosity, thickness, etc.) made using the same hydrophilic polymer but not having ionic pendant therefrom, e.g., at least 10, 25, 50, or 100 percent greater dye-binding capacity.

Particle retention can be measured as by measuring the number of test particles removed from a fluid stream by a membrane placed in the fluid stream. By one method, particle retention can be measured by passing a sufficient amount of an aqueous feed solution of 0.1% Triton X-100, containing 8 ppm polystyrene particles (0.025 μm Green Fluorescent Polymer Microspheres, Fluoro-Max (available from ThermoFisher SCIENTIFIC)), to achieve 0.5, 1, and 2% monolayer coverage through the membrane at a constant flow of 7 milliliters per minute, and collecting the permeate. The concentration of the polystyrene particles in the permeate can be calculated from the absorbance of the permeate. Particle retention is then calculated using the following equation:

$$particleretention = \frac{[ feed ] - [ filtrate ]}{[ feed ]} \times 100 \% .$$

In preferred embodiments of composite membranes as described, a composite membrane can exhibit a retention that exceeds 90 percent for monolayer coverages of 0.5%, 1.0%, 1.5%, and 2.0%, and may also exceed 95 percent for monolayer coverages of 0.5% and 1.0%. With this level of retention, these examples of the inventive composite membranes exhibit a higher retention level as compared to many currently commercial filter membranes, such as comparable flat sheet and hollow fiber filter membranes made of UPE. These example composite membranes also allow for useful, good, or very good rates of flow (low flow time), and exhibit mechanical properties that allow the composite membranes to be prepared and assembled into a filter cartridge or filter product.

In addition, a filter membrane as described can be characterized by a flow rate or flux of a flow of liquid through the filter membrane. The flow rate must be sufficiently high to allow the filter membrane to be efficient and effective for filtering a flow of fluid through the filter membrane. A flow rate, or as alternately considered, a resistance to a flow of liquid through a filter membrane, can be measured in terms of flow rate or flow time (which is an inverse to flow rate). A filter membrane as described herein, including a hydrophilic polymer with pendant ionic groups, can preferably have a relatively low flow time, preferably in combination with a bubble point that is relatively high, and good filtering performance (e.g., as measured by particle retention, dye-binding capacity, or both). An example of a useful or preferred flow time can be below about 6,000 seconds/500 mL, e.g., below about 4,000 or 2,000 seconds/500 mL.

Membrane water flow time can be determined by cutting membranes into 47 mm disks and wetting with water before placing the disk in a filter holder attached to a reservoir for holding a volume of water. The reservoir is connected to a pressure regulator. Water is flowed through the membrane under 14.2 psi (pounds per square inch) differential pressure. After equilibrium is achieved, the time for 500 ml of water to flow through the membrane is recorded.

Preferably, a flow time of a filter membrane made using hydrophilic polymer, and having pendant ionic groups as described, can be approximately equal to and not significantly greater than a flow time of the same filter membrane that does not contain the pendant hydrophilic groups. In other words, having the ionic groups on the hydrophilic polymer of the filter membrane does not have a substantial negative impact on the flow properties of the filter membrane, yet may still improve the filtering function of the filter membrane, especially the non-sieving filtering function of the membrane, e.g., as measured by dye-binding capacity, particle retention, or both. According to preferred filter membranes, a flow time measured of a filter membrane of the present description, including hydrophilic polymer and pendant ionic groups, can be not more than 30 percent or 20 percent, e.g., not more than 10 percent, 5, or 3 percent different from (e.g., greater than) the flow time of the identical hydrophilic polymer that does not include the grafted ionic groups.

A filter membrane as described can be contained within a larger filter structure such as a multilayer filter assembly or a filter cartridge that is used in a filtering system. The filtering system will place the filter membrane, e.g., as part of a multi-layer filter assembly or as part of a filter cartridge, in a filter housing to expose the filter membrane to a flow path of a liquid chemical to cause at least a portion of the flow of the liquid chemical to pass through the filter membrane, so that the filter membrane removes an amount of the impurities or contaminants from the liquid chemical. The structure of a multi-layer filter assembly or filter cartridge may include one or more of various additional materials and structures that support the composite filter membrane within the filter assembly or filter cartridge to cause fluid to flow from a filter inlet, through the composite membrane (including the filter layer), and thorough a filter outlet, thereby passing through the composite filter membrane when passing through the filter. The filter membrane supported by the filter assembly or filter cartridge can be in any useful shape, e.g., a pleated cylinder, a cylindrical pad, one or more non-pleated (flat) cylindrical sheets, a pleated sheet, among others.

One example of a filter structure that includes a filter membrane in the form of a pleated cylinder can be prepared to include the following component parts, any of which may be included in a filter construction but may not be required: a rigid or semi-rigid core that supports a pleated cylindrical coated filter membrane at an interior opening of the pleated cylindrical coated filter membrane; a rigid or semi-rigid cage that supports or surrounds an exterior of the pleated cylindrical coated filter membrane at an exterior of the filter membrane; optional end pieces or “pucks” that are situated at each of the two opposed ends of the pleated cylindrical coated filter membrane; and a filter housing that includes an inlet and an outlet. The filter housing can be of any useful and desired size, shape, and materials, and can preferably be made of suitable polymeric materials.

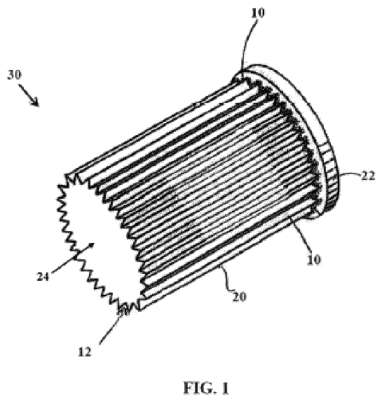

As one example, FIG. 1 shows filter component 30, which is a product of pleated cylindrical component 10 and end piece 22, with other optional components. Cylindrical component 10 includes a filter membrane 12, as described herein, and is pleated. End piece 22 is attached (e.g., “potted”) to one end of cylindrical filter component 10. End piece 22 can preferably be made of a melt-processable polymeric material. A core (not shown) can be placed at the interior opening 24 of pleated cylindrical component 10, and a cage (not shown) can be placed about the exterior of pleated cylindrical component 10. A second end piece (not shown) can be attached (“potted”) to the second end of pleated cylindrical component 30. The resultant pleated cylindrical component 30 with two opposed potted ends and optional core and cage can then be placed into a filter housing that includes an inlet and an outlet and that is configured so that an entire amount of a fluid entering the inlet must necessarily pass through filtration membrane 12 before exiting the filter at the outlet.

### EXAMPLES

### Example 1: Benzophenone Dissolved in a Mixture of Deionized Water and Isopropanol for Grafting of Monomers to Nylon

This example demonstrates how the use of a 50:50 deionized water to isopropanol mixture as a solvent is superior to 100% isopropanol for benzophenone while surface modifying nylon.

A nylon membrane with HFE mean bubble point of 107 psi, water flow time of 1220 seconds/500 mL, and thickness of 165 μm was surface modified using the following two methods. For the first experiment, the unmodified nylon membrane was cut into 47 mm diameter coupons. For step one, the coupons were submerged in a solution of 0.5% benzophenone in 100% isopropanol (IPA). For step two, IPA wetted nylon membrane coupons were then submerged into 100% deionized water. For step three, the deionized water-exchanged membranes were then submerged in a monomer solution to imbibe the membrane with the negatively charged monomer 2-Acrylamido-2-methyl-1-propanesulfonic acid (AMPS). For step four, the coupons were removed from the monomer solution and immediately placed between two clear polyethylene sheets and run through a Fusion Systems broad band UV lamp at a speed of 12 feet/minute. For step 5, the UV cured membrane coupons were washed with water and twice in methanol, then dried. During this process, the 47 mm nylon coupons became visually deformed due to the time spent in the benzophenone and isopropanol solution. For the second experiment, 1.0% Benzophenone was dissolved in 49 g isopropanol, and then diluted with 50 g deionized water. This solution replaced the solution of 0.5% benzophenone in 100% isopropanol that was used in step one of the first experiment. The remainder steps two through five were repeated exactly as the first experiment. The nylon membrane coupons in the second experiment were able to be modified without any visual deformation.

### Example 2: Nylon Surface Modified With Negatively Charged AMPS Monomer

This Example demonstrates surface modification of nylon membrane with a negatively charged monomer, 2-Acrylamido-2-methyl-1-propanesulfonic acid (AMPS).

A negatively charged nylon membrane was produced by surface modification. The surface modification was achieved by using a photo-initiator to covalently graft the negatively charged monomer AMPS to the membrane surface. First, an unmodified nylon membrane similar to that of Example 1 was cut into 47 mm diameter coupons, and then submerged in a solution of 0.5% benzophenone in 50% isopropanol and 50% deionized water. Next, the membrane was exchanged in a solution of 100% deionized water. The exchanged membrane was then submerged in an AMPS monomer solution (Table 1A) to imbibe the membrane with monomer solution. The coupons were removed from the monomer solution and immediately placed between two clear polyethylene sheets and run through a Fusion Systems broad band UV lamp at a speed of 12 feet/minute. The UV-cured membrane coupons were washed with water and twice in methanol, and then dried. The HFE mean bubble point of the native membrane was measured to be 107 psi and was not impacted by the surface modification. The flowtime percent increase due to the surface modification was measured to be 14%.

TABLE 1A
AMPS Monomer Solution

| 2-Acrylamido-2- | |
|---|---|
| methyl-1-propanesulfonic acid (g) | Deionized Water (g) |
| 2.0 | 98.0 |

### Example 3: Nylon Surface Modified With Negatively Charged VPA Monomer

This Example demonstrates surface modification of nylon membrane with a negatively charged monomer, Vinyl Phosphonic Acid (VPA).

A negatively charged nylon membrane was produced by surface modification. The surface modification was achieved by using a photo-initiator to graft the negatively charged monomer VPA to the membrane covalently. First, an unmodified nylon membrane similar to that of Example 1 was cut into 47 mm diameter coupons, and then submerged in a solution of 0.5% benzophenone in 50% isopropanol and 50% deionized water. Next, the membrane was exchanged in a solution of 100% deionized water. The exchanged membrane was then submerged in a VPA monomer solution (Table 1B) to imbibe the membrane with monomer solution. The coupons were removed from the monomer solution and immediately placed between two clear polyethylene sheets and run through a Fusion Systems broad band UV lamp at a speed of 12 feet/minute. The UV cured membrane coupons were washed with water and twice in methanol, and then dried. The HFE mean bubble point of the native membrane was measured to be 107 psi and was not impacted by the surface modification. The flowtime percent increase due to the negatively charged surface modification was measured to be 0.0%.

TABLE 1B
VPA Monomer Solution

| Vinyl Phosphonic Acid (g) | Deionized Water (g) |
|---|---|
| 6.0 | 94.0 |

### Example 4: Determination of Dye Binding Capacity of Negatively Charged Nylon Membranes

This example demonstrates how the degree of negative charge present on a treated porous nylon membrane can be approximated by measuring the uptake of the positively charged dye molecule Methylene blue.

This method is used to measure the amount of charge applied to surface modified nylon membrane. First, each coupon (e. g. of Example 2 and 3) is rewet in isopropanol and immediately placed in a 50 mL conical tube containing 50 mL of a dilute (0.00075% weight percentage) methylene blue dye (Sigma Aldrich) feed solution and the tube is capped and rotated for 2 hours. After 2 hour rotation, the membrane coupon is removed from the methylene blue solution and placed in a 50 mL conical tube containing 50 mL of 100% solution of isopropanol, the tube is capped and rotated for 0.5 hours. After rotation in isopropanol the membrane coupon is confirmed visually to be dyed blue and the coupon is dried. The UV absorbance of the dilute methylene blue feed solution is measured and compared to that of the solutions the coupon has been rotated in. By determining the difference in UV absorbance from the original solution in comparison to the rotated solutions, a final “Dye-Binding Capacity” (DBC) can be calculated and expressed in μg/cm². This number is an approximation of the level of charged functional groups on the surface of a membrane and is correlated to the level of membrane ion-exchange capacity. The methylene blue DBC for the base nylon was 0.0 μg/cm², the DBC for the nylon surface modified with negatively charged AMPS from Example 2 was determined to be 43.88 μg/cm², and the DBC for the nylon membrane surface modified with VPA from Example 3 was determined to be 14.3 μg/cm².

### Example 5: Nylon Surface Modified With Positively Charged APTAC Monomer

This Example demonstrates surface modification of nylon membrane with a positively charged monomer, (3-Acrylamidopropyl) trimethylammonium chloride (APTAC).

A positively charged nylon membrane was produced by surface modification. The surface modification was achieved by using a photo-initiator to graft the positively charged monomer APTAC to the membrane covalently. First, an unmodified nylon membrane similar to that of Example 1 was cut into 47 mm diameter coupons, and then submerged in a solution of 0.5% benzophenone in 50% isopropanol and 50% deionized water. Next, the membrane was exchanged in a solution of 100% deionized water. The exchanged membrane was then submerged in an APTAC monomer solution (Table 1C) to imbibe the membrane with monomer solution. The coupons were removed from the monomer solution and immediately placed between two clear polyethylene sheets and run through a Fusion Systems broad band UV lamp at a speed of 12 feet/minute. The UV cured membrane coupons were washed with water and twice in methanol, and then dried. The HFE mean bubble point of the native membrane was measured to be 107 psi and was not impacted by the surface modification. The flowtime percent increase due to the positively charged surface modification was measured to be 13.8%.

TABLE 1C
APTAC Monomer Solution

| (3-Acrylamidopropyl) | |
|---|---|
| trimethylammonium chloride solution | |
| (75% in deionized water) (g) | Deionized Water (g) |
| 2.66 | 97.34 |

### Example 6: Nylon Surface Modified With Positively Charged IM Monomer

This Example demonstrates surface modification of nylon membrane with a positively charged monomer, 1-Vinyl Imidazole (IM).

A positively charged nylon membrane was produced by surface modification. The surface modification was achieved by using a photo-initiator to graft the positively charged monomer IM to the membrane covalently. First, an unmodified nylon membrane similar to that of Example 1 was cut into 47 mm diameter coupons, and then submerged in a solution of 0.5% benzophenone in 50% isopropanol and 50% deionized water. Next, the membrane was exchanged in a solution of 100% deionized water. The exchanged membrane was then submerged in an IM monomer solution (Table 1D) to imbibe the membrane with monomer solution. The coupons were removed from the monomer solution and immediately placed between two clear polyethylene sheets and run through a Fusion Systems broad band UV lamp at a speed of 12 feet/minute. The UV cured membrane coupons were washed with water and twice in methanol, and then dried. The HFE mean bubble point of the native membrane was measured to be 107 psi and was not impacted by the surface modification. The flowtime percent increase due to the IM surface modification was measured to be 0.0%.

TABLE 1D
IM Monomer Solution

| 1-Vinyl Imidazole (g) | Deionized Water (g) |
|---|---|
| 2.0 | 98.0 |

### Example 7: Nylon Surface Modified With Positively Charged APTAC Monomer Through Air Dried Grafting

This example demonstrates surface modification of nylon membrane with a positively charged monomer, (3-Acrylamidopropyl) trimethylammonium chloride (APTAC), through grafting with air-dried photo initiator.

A positively charged nylon membrane was produced by surface modification. The surface modification was achieved by using a photo-initiator to graft the positively charged monomer APTAC to the membrane covalently. First, an unmodified nylon membrane similar to that of Example 1 was cut into 47 mm diameter coupons. The membrane was then removed from solution, and dried at room temperature while restrained. The dried membrane was then submerged in an APTAC monomer solution (Table 1E) to imbibe the membrane with monomer solution. The coupons were removed from the monomer solution and immediately placed between two clear polyethylene sheets and run through a Fusion Systems broad band UV lamp at a speed of 12 feet/minute. The UV cured membrane coupons were washed with water and twice in methanol, and then dried. The HFE mean bubble point of the native membrane was measured to be 107 psi and was not impacted by the surface modification. The flowtime percent increase due to the positively charged surface modification was measured to be 1.6%.

TABLE 1E
APTAC Monomer Solution

| (3-Acrylamidopropyl) trimethylammonium chloride | Deionized |
|---|---|
| solution (75% in deionized water) (g) | Water (g) |
| 2.66 | 97.34 |

### Example 8: Alkaline Primed Nylon Surface Modified With Positively Charged APTAC Monomer Through Air-Dried Grafting

This example demonstrates surface modification of an alkaline primed nylon membrane with a positively charged monomer, (3-Acrylamidopropyl) trimethylammonium chloride (APTAC), through grafting with air dried photo-initiator.

A positively charged nylon membrane was produced by surface modification. The surface modification was achieved by using a photoinitiator to graft the positively charged monomer APTAC to the membrane covalently. First, an unmodified nylon membrane similar to that of Example 1 was cut into 47 mm diameter coupons, and then submerged in a solution of deionized water (DIW) brought to pH 11 with 1M sodium hydroxide. The membrane was then removed from solution and dried at room temperature while restrained. The membrane was then submerged in a solution of 0.5% benzophenone in 50% isopropanol and 50% deionized water. The membrane was then removed from solution and dried at room temperature while restrained. The dried membrane was then submerged in an APTAC monomer solution (Table 1F) to imbibe the membrane with monomer solution. The coupons were removed from the monomer solution and immediately placed between two clear polyethylene sheets and run through a Fusion Systems broad band UV lamp at a speed of 12 feet/minute. The UV cured membrane coupons were washed with water and twice in methanol, and then dried. The HFE mean bubble point of the native membrane was measured to be 107 psi and was not impacted by the surface modification. The flowtime percent increase due to the positively charged surface modification was measured to be 9.4%.

TABLE 1F
APTAC Monomer Solution

| (3-Acrylamidopropyl) trimethylammonium | Deionized |
|---|---|
| chloride solution (75% in deionized water) (g) | Water (g) |
| 2.66 | 97.34 |

### Example 9: Determination of Dye Binding Capacity of Positively Charged Nylon Membranes

The example demonstrates how the degree of positive charge present on a treated porous nylon membrane can be approximated by measuring the uptake of the negatively charged dye molecule Ponceau S.

This method is used to measure the amount of charge applied to surface modified nylon membrane. First, each coupon (e. g. of Example 5, 6, 7, and 8) is rewet in isopropanol and immediately placed in a 50 mL conical tube containing 50 mL of a dilute (0.005% weight percentage) Ponceau S Red dye (Sigma Aldrich) feed solution and the tube is capped and rotated for 2 hours. After 2 hour rotation, the membrane coupon is removed from the Ponceau S solution and placed in a 50 mL conical tube containing 50 mL of 100% solution of isopropanol, the tube is capped and rotated for 0.5 hours. After rotation in isopropanol the membrane coupon is confirmed visually to be dyed red and the coupon is dried. The UV absorbance of the Ponceau S feed solution is measured and compared to that of the solutions the coupon has been rotated in. By determining the difference in UV absorbance from the original solution in comparison to the rotated solutions, a final “Dye-Binding Capacity” (DBC) can be calculated and expressed in μg/cm². This number is an approximation of the level of charged functional groups on the surface of a membrane and is correlated to the level of membrane ion-exchange capacity. The Ponceau S DBC for the nylon base membrane was 34.5 μg/cm², the DBC for the nylon surface modified with positively charged APTAC was determined to be 48.90 μg/cm², the DBC for the nylon surface modified with positively charged APTAC through the use of air dried photo-initiator was determined to be 47.44 μg/cm², the DBC for the nylon surface modified with positively charged APTAC through alkaline priming and dried photo-initiator was determined to be 62.32 μg/cm², and the DBC for that with IM was determined to be 99.61 μg/cm².

### Example 10: Determination of Filter Retention of G25 Beads for Nylon Membrane, Negatively Charged Nylon Membrane, and Positively Charged Membrane

The following example demonstrates introduction of additional charged functional groups to a nylon membrane can maintain or improve retentive properties of the membrane.

Filter retention of G25 Beads (0.025 μm Green Fluorescent Polymer Microspheres, Fluoro-Max) was determined for a nylon membrane, a nylon membrane that was modified with a negative charge using a method similar to Example 2, and a nylon membrane that was modified with a positive charge using a method similar to Example 5. A feed solution of 8 ppb G25 Beads with 0.1% Triton-X (Sigma) was prepared in deionized water and the pH was adjusted to 10.6. Nylon membrane coupons were cut and the membrane was secured into a 47 mm filter assembly. The membrane assembly containing the nylon membrane was flushed with deionized water followed by flushing with 0.1% Triton-X in deionized water adjusted to pH 10.6. The solution prepared with G25 and Triton-X at pH 10.6 was filtered through the membrane and the filtrate was collected at calculated bead loadings of 0.5, 1, 2% monolayer. The collected filtrate samples are compared to the 8 ppb G25 Bead 0.1% Triton-X feed solution by calculating the G25 Bead concentration using a fluorescence spectrophotometer. The percent removal at various monolayers for the membranes can be calculated. The nylon membrane modified with positive charge demonstrated improved G25 Bead retention when compared to the unmodified nylon membrane. The results are depicted in Retention (%) for Monolayer 0.5, 1, and 2% in Table 1H: Metal Removal in Water.

TABLE 1G
Filter Retention of G25 Beads

| | 0.5% Monolayer | 1% Monolayer | 2.0% Monolayer |
|---|---|---|---|
| Sample | (Retention %) | (Retention %) | (Retention %) |
| Nylon | 90.4 | 83.3 | 74.7 |
| Negative Charged | 90.3 | 83.7 | 79.1 |
| Nylon | | | |
| Positive Charged | 98.8 | 96.4 | 91.9 |
| Nylon | | | |

### Example 11: Determination of Metal Removal in DIW Using Native Nylon Membrane and Negatively Charged Nylon Membrane

The following example demonstrates introduction of additional negatively charged functional groups to a nylon membrane can improve metal removal properties of the membrane.

Negatively charged Nylon membranes were prepared using a method similar to example 2 and cut into 47 mm membrane coupons. These membrane coupons were conditioned by washing several times with 0.35% HCl followed by soaking in 0.35% HCl overnight and equilibrated with deionized water. For each sample, one 47 mm membrane coupon was secured into a clean PFA 47 mm Single Stage Filter Assembly (Savillex). The membrane and filter assembly were flushed with DIW. The DIW was spiked with an aqueous metal standard that contained 21 metals (SCP Science) to achieve a target concentration of 5 ppb of each metal. To determine the filtration metal removal efficiency the metal spiked DIW was passed through the corresponding 47 mm filter assembly containing each filter at 10 mL/min and the filtrate was collected into a clean PFA jar at 100 mL. The metal concentration for the metal spiked DIW and the filtrate sample was determined using ICP-MS. The results are depicted in Metals Removal (%) in Table 1H: Metal Removal in Water.

TABLE 1H
Metal Removal in Water

| | Nylon with 5% AMPS | Native Nylon |
|---|---|---|
| Metal | (Percent Removal) | (Percent Removal) |
| Li | 0.00 | 0.00 |
| Be | 5.14 | 0.00 |
| Na | 9.23 | 5.31 |
| Mg | 91.55 | 0.00 |
| Al | 0.00 | 0.00 |
| K | 0.00 | 1.25 |
| Ca | 88.07 | 14.47 |
| Ti | 0.00 | 0.00 |
| Cr | 56.59 | 0.00 |
| Mn | 96.04 | 0.00 |
| Fe | 93.32 | 0.00 |
| Ni | 92.51 | 0.00 |
| Co | 95.93 | 0.00 |
| Cu | 95.63 | 0.00 |
| Zn | 96.37 | 0.00 |
| Sr | 96.71 | 0.00 |
| Ag | 0.00 | 0.00 |
| Cd | 97.80 | 0.00 |
| Ba | 98.26 | 0.00 |
| Tl | 0.00 | 0.00 |
| Pb | 99.62 | 0.00 |
| Tree Removal (%) | 52.65 | 1.70 |

In a first aspect, a porous polymeric filter membrane comprises: a hydrophilic polymer comprising: a polymer backbone; pendant hydrophilic groups selected from the group consisting of hydroxyl groups, amine groups, carboxylic groups, and combinations thereof; and pendant ionic groups that are different from the pendant hydrophilic groups.

A second aspect according to the first aspect, wherein the pendent ionic groups are effective to improve the non-sieving filtering performance of the filter membrane compared to a filter membrane that is the same but does not include the pendant ionic groups.

A third aspect according to the first or second aspect, wherein the polymer backbone is a polyamide.

A fourth aspect according to any of the preceding aspects, wherein the ionic group is a cationic nitrogen-containing group, an anionic sulfur-containing group, or an anionic phosphorus-containing group.

A fifth aspect according to any of the preceding aspects, wherein the ionic group is a cationic nitrogen-containing cyclic aromatic group.

A sixth aspect according to any of the first through fourth aspects, wherein the ionic group is cationic imidazole or a cationic amine.

A seventh aspect according to any of the first through fourth aspects, wherein the ionic group is anionic phosphonic acid or anionic sulfonic acid.

An eighth aspect according to any of the preceding aspects, further comprising residual photoinitiator.

A ninth aspect according to any of the preceding aspects, wherein the porous polymeric filter membrane has a porosity of at least 60 percent.

A tenth aspect according to any of the preceding aspects, wherein the porous polymeric filter membrane has a pore size in a range from 0.001 to 1.0 microns.

In an eleventh aspect, a filter cartridge includes a membrane of any of the first through tenth aspects

In a twelfth aspect, a filter includes a membrane of any of the first through tenth aspects.

In a thirteenth aspect, a method of using a filter membrane of any of first through tenth aspect comprises passing solvent-containing liquid through the membrane.

In a fourteenth aspect, a method of grafting ionic groups to a hydrophilic polymer, the method comprises: contacting a hydrophilic polymer with a photoinitiator solution comprising solvent and photoinitiator, to place the photoinitiator at surfaces of the hydrophilic polymer; after contacting the surfaces with the photoinitiator solution to place the photoinitiator at the surfaces, contacting the surfaces with a monomer solution comprising charged monomer, wherein the charge monomer comprises ionic groups; and exposing the surfaces to electromagnetic radiation to cause the ionic groups to become grafted to the hydrophilic polymer.

A fifteenth aspect according to the fourteenth aspect, wherein the hydrophilic polymer is a porous polymeric filter membrane.

A sixteenth aspect according to the fourteenth or fifteenth aspect, wherein the solvent comprises organic solvent and water.

A seventeenth aspect according to any of the fourteenth through sixteenth aspects, comprising: after contacting the surfaces with the photoinitiator solution, at least partially drying the surfaces by evaporation of the solvent, and after at least partially drying the photoinitiator solution, contacting the membrane with the monomer solution.

An eighteenth aspect according to any of the fourteenth through seventeenth aspects, wherein the photoinitiator is benzophenone or a benzophenone derivative.

A nineteenth aspect according to any of the fourteenth through eighteenth aspects, wherein the photoinitiator solution comprises from 0.1 to 2 weight percent benzophenone or benzophenone derivative, and the photoinitiator solution includes water and one or more of isopropanol and methanol.

A twentieth aspect according to any of the fourteenth through nineteenth aspects, wherein the charged monomer comprises vinyl imidazole, 2-acrylamido-2-methylpropane sulfonic acid, (3-acrylamido propyl)trimethyl ammonium chloride, vinyl sulfonic acid, vinyl phosphonic acid, acrylic acid, (vinylbenzyl)trimethylammonium chloride, or polydiallyldimethylammonium chloride.

1. A method of grafting ionic groups to a hydrophilic polymer, the method comprising:
contacting a hydrophilic polymer with a photoinitiator solution comprising solvent and photoinitiator, to place the photoinitiator at surfaces of the hydrophilic polymer;
after contacting the surfaces with the photoinitiator solution to place the photoinitiator at the surfaces, contacting the surfaces with a monomer solution comprising charged monomer, wherein the charge monomer comprises ionic groups; and
exposing the surfaces to electromagnetic radiation to cause the ionic groups to become grafted to the hydrophilic polymer.

2. The method of claim 1, wherein the hydrophilic polymer is a porous polymeric filter membrane.

3. The method of claim 1, wherein the solvent comprises organic solvent and water.

4. The method of claim 1, comprising:
after contacting the surfaces with the photoinitiator solution,
at least partially drying the surfaces by evaporation of the solvent, and
after at least partially drying the photoinitiator solution, contacting the membrane with the monomer solution.

5. The method of claim 1, wherein the photoinitiator is benzophenone or a benzophenone derivative.

6. The method of claim 1, wherein the photoinitiator solution comprises from 0.1 to 2 weight percent benzophenone or benzophenone derivative, and the photoinitiator solution includes water and one or more of isopropanol and methanol.

7. The method of claim 1, wherein the charged monomer comprises vinyl imidazole, 2-acrylamido-2-methylpropane sulfonic acid, (3-acrylamido propyl)trimethyl ammonium chloride, vinyl sulfonic acid, vinyl phosphonic acid, acrylic acid, (vinylbenzyl)trimethylammonium chloride, or polydiallyldimethylammonium chloride.
